(19) United States
(12) Patent Application Publication
(10) Pub. No.: US 2010/0271910 A1
(43) Pub. Date: Oct. 28, 2010

(54) METHOD AND APPARATUS FOR NEAR FIELD PHOTOPATTERNING AND IMPROVED OPTICAL COUPLING EFFICIENCY

(76) Inventor: Zine-Eddine Boutaghou, North Oaks, MN (US)

Correspondence Address: Clise, Billion & Cyr, P.A., 605 U.S. Highway 169, Suite 300, Plymouth, MN, 55441, US

(21) Appl. No.: 12/765,518

(22) Filed: Apr. 22, 2010

Related U.S. Application Data
(60) Provisional application No. 61/172,685, filed on Apr. 24, 2009.

(51) Int. Cl. G11B 11/00

(52) U.S. Cl. 369/13.33; G9B/11

(57) ABSTRACT

This invention relates to near field assemblies with improved optical coupling efficiency suitable for near field photolithography and heat assisted magnetic recording with fluid bearing structures. Masters for photolithography are fabricated using a fluid bearing suspended at a near field distance using hydrostatic bearings. Near field features fabricated on a fluidized slider emit a radiated laser to develop a photo-resist layer deposited on the master replicator. A plurality of near field assemblies is etched on a wafer. Each of the near field assemblies includes a planar solid immersion mirror, at least one grating, and a near field transducer. The features created during the etching step are used to guide at least one milling tool to machine at least one surface on one or more of the planar solid immersion mirror, the at least one grating, and the near field transducer. The features created during the machining step are used to guide at least one polishing tool to polish at least one surface on one or more of the planar solid immersion mirror, the at least one grating, and the near field transducer. The wafer is cut to create a plurality of discrete near field assemblies.

### CROSS-REFERENCE TO RELATED APPLICATIONS

This application claims the benefit of the filing date of U.S. Provisional Patent Application Ser. No. 61/172,685 filed Apr. 24, 2009, which is entitled “Plasmon Head with Hydrostatic Gas Bearing for Near Field Photolithography” which is hereby incorporated herein in its entirety by reference.

### FIELD OF THE INVENTION

This invention relates to near field assemblies with improved optical coupling efficiency suitable for near field photolithography and heat assisted magnetic recording with fluid bearing structures.

### BACKGROUND OF THE INVENTION

The efficiency of energy transfer between the incident radiation and near field transducers is relatively low. The coupling efficiency from the amount of incoming light from the laser with respect to the amount of light received by the near field transducer is about 2 percent versus a theoretical efficiency of about 30 percent to about 40 percent. Increased efficiency of coupling light energy to near field assemblies has applications in both heat assisted magnetic recording and nano-photolithography.

Heat assisted magnetic recording (“HAMR”) has been proposed to increase the recording density of hard disc drives to 1 Terabyte/inch² higher. The magnetic anisotropy of the recording medium, i.e. its resistance to thermal demagnetization, is greatly increased when heated, while still allowing the data to be recorded with standard recording fields. In application, a laser beam heats the area on the disc that is to be recorded and temporarily reduces the anisotropy in just that area sufficiently so that the applied recording field is able to set the magnetic state of that area. After cooling back to the ambient temperature, the anisotropy returns to its high value and stabilizes the magnetic state of the recorded mark. U.S. Pat. No. 7,272,079 (Challener) discloses an apparatus for heat assisted magnetic recording, which is incorporated by reference.

With regard to nano-photolithography, the continuing size reduction of integrated circuits to nanometer (nm) scale dimensions requires the development of new lithographic techniques. The ultimate resolution of conventional photolithography is restricted by the diffraction limit. It is becoming increasingly difficult and complex to use the established method of optical projection lithography at the short optical wavelengths required to reach the desired feature sizes. For example, the use of wavelengths in the deep ultraviolet, the extreme ultraviolet (EUV), or the X-ray regime requires increasingly difficult adjustments of the lithographic process, including the development of new light sources, photo-resists, and optics.

U.S. Pat. Publication No. 2003/0129545 (Kik et al.) discloses a method for performing nanolithography using a photo-mask with conductive nanostructures disposed thereon. The nanostructures have a plasmon resonance frequency that is determined by the dielectric properties of the surroundings and of the nanostructures, as well as the nanostructure shape. The nanostructures are illuminated with light at or near the frequency of the plasmon resonance frequency, which causes collective oscillations of the electrons at the surface of the nanostructure. These oscillations can have wavelengths that are much shorter than the wavelength of the light that excited them, which are sufficient to modify adjacent portions of the resist layer. The resist layer is developed to create plasmon printed, subwavelength patterns. Creating the photo-mask, however, is time intensive, expensive, and does not easily permit design changes.

The commercialization of nanoscale devices requires the development of high-throughput nanofabrication technologies that allow frequent design changes. Maskless nanolithography, including electron-beam and scanning-probe lithography, offers the desired flexibility, but is limited by low throughput and extremely high cost.

U.S. Pat. Publication No. 2007/0069429 (Albrecht et al.) is directed to a system and method for patterning a master disk to be used for nanoimprinting magnetic recording disks. An air-bearing created by a rotating master disk substrate supports a slider with an aperture structure within the optical near-field of a resist layer. The fly height of the slider is typically about 10 to about 20 nanometers. A liquid lubricant and/or a protective film, such as a carbon film, may be provided on the resist layer to improve the flyability of the slider supporting the plasmonic head. The timing of the laser pulses is controlled to form a pattern of exposed regions in the resist layer, with this pattern ultimately resulting in the desired pattern of data islands and non-data islands in magnetic recording disks when they are nanoimprinted by the master disk.

The spinning master disk of Albrecht is essential to establish the air bearing between the slider and the photo-resist. The spinning master disk, however, is subject to vibration and spindle run-out errors that lead to patterning errors and potential collisions between the slider and the photo-resist. Roughness of the photo-resist and media needs to be closely controlled to enable the slider to fly without crashing. If the plasmonic lens contacts the master disk it can be coated with photo-resist, potentially smearing the lens and causing patterning errors. Finally, a spinning master disk is not a practical method of making more complex structures, such as for example micro electrical mechanical systems (MEMS).

### BRIEF SUMMARY OF THE INVENTION

The present invention is directed to near field heads with improved optical coupling efficiency suitable for heat assisted magnetic recording and near field photolithography.

The near field assemblies are first patterned using photo lithography methods. A vision system uses the features created by the etching process as a reference for subsequent machining and polishing operations. The machining and polishing steps are primarily directed to the sidewalls of the planar solid immersion mirror, the gratings and the near field transducer. The top surface of the wafer can also be polished prior to gold/silver deposition. Wafer level machining operations are capable of generating near vertical sidewall profiles and smooth surface in the range of less than about 10 nanometers.

The preset invention is also directed to micromachining tools for fabricating the near field assemblies. The cutting surfaces of the tools are preferably coated with nano-scale diamonds. The diamonds can be prepared by engaging the spinning cutting surface with one or more abrasive surfaces of various roughness.

One embodiment is directed to a method of fabricating a near field assembly. A plurality of near field assemblies are etched on a wafer. Each of the near field assemblies includes a planar solid immersion mirror, at least one grating, and a near field transducer. The features created during the etching step are used to guide at least one milling tool to machine at least one surface on one or more of the planar solid immersion mirror, the at least one grating, and the near field transducer. The features created during the machining step are used to guide at least one polishing tool to polish at least one surface on one or more of the planar solid immersion mirror, the at least one grating, and the near field transducer. The wafer is cut to create a plurality of discrete near field assemblies.

The present invention is also directed to a low-cost approach to near field nano-scale photolithography using a near field assembly with hydrostatic gas bearings. The hydrostatic gas bearing flies the near field assembly at less than 100 nm, and more preferably less than 25 nm, above the photo-resist without the need to spin the substrate. The near field assembly concentrates short-wavelength surface plasmons into about sub-100 nm regions on the photo-resist and can pattern features of about 80 nm or less. This nanofabrication system has the potential to provide desktop, maskless nanophotolithography at several orders of magnitude lower cost than current maskless techniques. Nano-scale typically refers to features with dimensions of less than one micrometer (1×10⁻⁶ meters).

At least one near field assembly is preferably located at the trailing edge of the slider. Alternatively, one or more lenses are mounted on the slider. For commercial applications, a plurality of near field assemblies are provided on each slider.

The slider is supported by a suspension assembly fabricated with air channels connected to an external air supply. The channels are fluidly coupled to openings in the air bearing surface of the slider. In one embodiment, channels are etched in the suspension assembly and a polyamide cover is applied over the channels to form gas conduits. The channels can be on the top or the bottom of the suspension assembly.

The hydrostatic gas bearing provides a controlled clearance between the substrate and the slider. The clearance is maintained by externally pressurizing a plurality of pads located on the air bearing surface of the slider in proximity with the substrate. Once the desired clearance is attained between the hydrostatic slider and the substrate, a laser is directed at a near field transducer located on the slider. The resulting emission from the near field transducer exposes the photo-resist.

In one embodiment, the externally pressurized gas bearing design allows for independently controlling the pressure on each pad of the hydrostatic bearing. Independent control of each gas port permits the pitch and roll of the slider to be adjusted to optimize the photolithographic process.

The clearance of the slider is preferably calibrated ex-situ on an optical fly height tester prior to usage. Each hydro-static pad pressure is calibrated to assure a near field gap. A sensor is preferably provided on the slider to monitor flying height. Heaters may also be provided to adjust the position of the near field assembly relative to the photo-resist.

The system includes an X-Y stage to accurately locate a substrate relative to the slider. A controller operating the X-Y stage and the laser assembly accurately expose the photo-resist to form the desired pattern. Since the substrate is not required to spin to maintain a gas bearing, transfer of vibration and spindle run-out errors to the pattern are minimized.

Micro electro mechanical systems (MEMS) methods are well suited for fabricating the present hydrostatic slider. For example, a silicon wafer is patterned with the gas bearing features. A series of through holes for the gas ports are machined with a deep reactive ion etch process (DRIE) or simply machined. Once the silicon wafers are patterned and fabricated, a series of slider bars are sliced to expose the slider sides for further processing. A thick dielectric such as alumina is sputtered at the end of slider. A planar solid immersion mirror with a dual offset grating used to focus a waveguide mode onto the near-field transducer (NFT) is fabricated onto the trailing edge of the slider.

The photolithography system includes a head suspension assembly with a load beam having a flexure at a distal end and a plurality of channels. A covering layer extends over the channels to form gas conduits. The slider includes a first surface attached to the flexure and a second surface facing the substrate. The first surface of the slider includes a plurality of ports fluidly coupled to the gas conduits. The ports extend through the slider and exit through holes in at least one air bearing surface located on the second surface. A near field assembly on the slider emits radiation onto a region of the photo-resist in response to incident radiation. A laser assembly supplies the incident radiation. A source of pressurized gas delivered to the gas conduits maintains a clearance between the near field assembly and the photo-resist layer. A controller synchronizes activation of the laser assembly with the position of the substrate relative to the near field assembly to form the desired pattern on the photo-resist layer.

The substrate must meet flatness requirements in order to establish a nanometer level gap without interference and smearing of the near field elements. The laser assembly supplies radiation at a first wavelength and the near field assembly emits radiation at a second shorter wavelength in response to incident radiation.

The present invention is also directed to a near field assembly for near field photolithography.

The present invention is directed to fabricating masters that can be used for further pattern transfers for feature replication purpose. A master is first fabricated with the present invention. Additional slaves are fabricated by photo-imprinting. The slaves are then used to fabricate pattern on finished magnetic media or substrates.

The present invention is also directed to a method for forming a pattern in photo-resist layer on a substrate using a photolithography system. A pressurized gas is delivered through conduits in a head suspension to ports on a slider. The pressurized gas is ejected from the ports in the slider to create a hydrostatic gas bearing with a clearance between a near field assembly and a photo-resist layer. Incident radiation is directed from a laser assembly to the near field assembly. Activation of the laser assembly is synchronized with a position of the substrate relative to the near field assembly to form the pattern.

The present invention is directed to fabricating a heat assisted magnetic head to render the edges of the gratings, near field sensor and edges of the optical tools smooth and free from defects rendered during the etching process. Milling operation heals the roughness and defects generated by the etching process.

### BRIEF DESCRIPTION OF THE SEVERAL VIEWS OF THE DRAWING

FIG. 1 is a schematic illustration of a maskless, nano-photolithography system with a hydrostatic gas bearing in accordance with an embodiment of the present invention.

FIG. 2A illustrates a near field assembly formed on an edge of a slider in accordance with an embodiment of the present invention.

FIG. 2B is a perspective view of the slider of FIG. 2A.

FIG. 2C is a schematic illustration of an alternate near field transducer in accordance with an embodiment of the present invention.

FIG. 3 is an exploded view of a head suspension in accordance with an embodiment of the present invention.

FIG. 4 is a top view of the head suspension of FIG. 3.

FIG. 5 is a bottom exploded view of the head suspension of FIG. 3.

FIG. 6 is a perspective view of an alternate head suspension in accordance with an embodiment of the present invention.

FIG. 7 is a bottom view of the slider of FIG. 6.

FIG. 8 is a schematic illustration of a near field assembly made using the methods of the present invention.

FIG. 9 is a side sectional view of a near field transducer of FIG. 8 positioned opposite a magnetic media in accordance with an embodiment of the present invention.

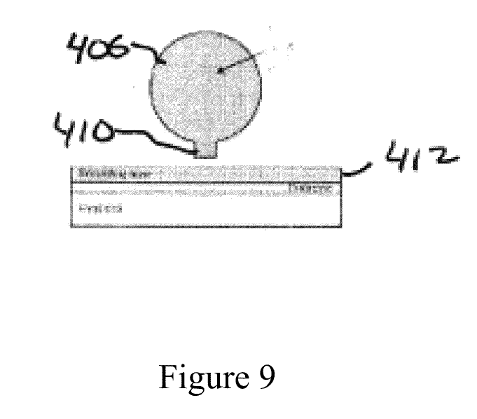

FIGS. 10 and 11 illustrate common defects in prior art near field assemblies.

FIG. 12 is a sectional view of a side wall of a planar solid immersion mirror on the near field assembly of FIG. 8.

FIGS. 13 and 14 are side sectional views of milling tools coated with nano-scale diamonds used in the method of the present invention.

FIGS. 15A-15C illustrate a method of preparing a tool for use in an embodiment of the present invention.

FIG. 16 is a top view of a wafer containing a plurality of near field assemblies in accordance with an embodiment of the present invention.

FIG. 17 is a perspective view of the present near field assembly used in a heat assisted magnetic recording application in accordance with an embodiment of the present invention.

### DETAILED DESCRIPTION OF THE INVENTION

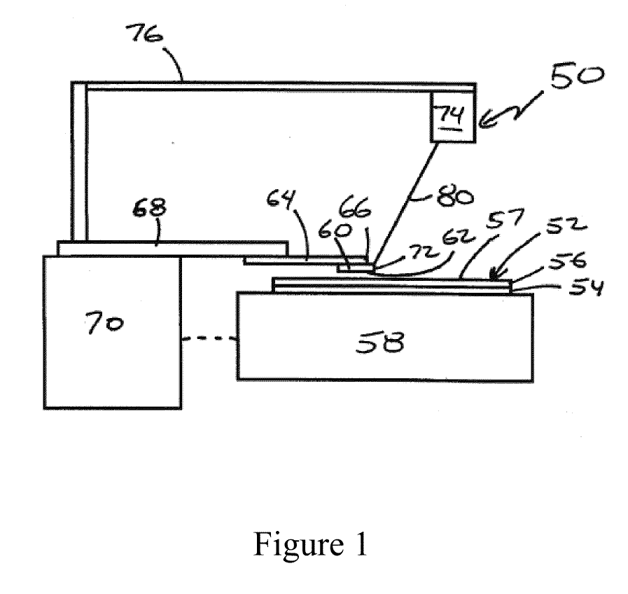

FIG. 1 is a schematic illustration of the system 50 for maskless, nano-scale, photolithography in accordance with an embodiment of the present invention. A master 52 including a substrate 54 with photo-resist layer 56 supported on a linear stage 58. Slider 60 has an air-bearing surface (ABS) 62 that is oriented toward the master 52.

The slider 60 is mounted on a suspension 64 similar to a conventional suspension like that used in magnetic recording disk drives, with a head gimbal assembly or flexure 66 that permits the slider 60 to “pitch” and “roll” relative to the master 52. The suspension 64 is connected to support arm 68 that is supported by controller 70. The support arm 68 applies a preload to the suspension 64 to maintain the flying ability of the slider 60.

In one embodiment, the support arm 68 is fixedly mounted on controller 70. In another embodiment, the support arm 68 is adapted to translate relative to the controller 70. Translation can include linear movement in the X, Y, and/or Z directions, as well as rotation around a fixed point. For example, a linear actuator can move the support arm 68 in the X-direction and/or Y-direction. Alternatively, a rotary actuator, such as a rotary voice-coil-motor (VCM) actuator, rotates the support arm 68 along a generally radial or arcuate path.

The slider 60 includes a near field assembly 72 that directs radiation from laser assembly 74 to the resist layer 56. The laser assembly 74 typically includes a laser, a modulator and one or more lenses. Alternatively, one or more lenses may be located on the slider 60. The laser assembly 74 is supported by armature 76 attached to the controller 70. In embodiments where the support arm 68 is permitted to translate relative to the controller 70, the armature 76 preferably translates with the support arm 68 so that the position of the laser assembly 74 relative to the near field assembly 72 is maintained. The master 52 is movable relative to the slider 60 by X-Y stage 58.

Radiation 80 from the laser assembly 74 may be directed to the near field assembly 72 using a variety of techniques, such as for example the system disclosed in U.S. Pat. No. 5,497,359 or U.S. Pat. Publication 2007/0069429, which are hereby incorporated by reference. Alternatively, the radiation 80 from laser assembly 74 may be delivered to the near field assembly 72 by optical fibers.

Most commonly used lasers are diode-pumped solid state lasers, e.g., Nd:YAG or Nd:YLF. These may be frequency multiplexed to give radiation at higher harmonics. For example a Nd:YAG laser with frequency multiplexing may be used to generate radiation at 1064 nm, 532 nm, 355 nm or 266 nm. Additionally, the radiation from the laser may be modulated using external modulators. Mode-locked lasers also provide rapid pulses with frequencies up to about 100 MHz. Other lasers such as pulsed diode lasers may also be used.

The controller 70 can be a specialty computer, a conventional PC, or a combination thereof. The controller 70 is programmed with the desired pattern to be created in the photo-resist 56. The control system 70 controls the X-Y stage 58 and activation of the laser assembly 74 to form the desired pattern in the resist layer 56 of master 52. In another embodiment, the laser assembly 74 delivers pulses on demand, in response to a trigger signal.

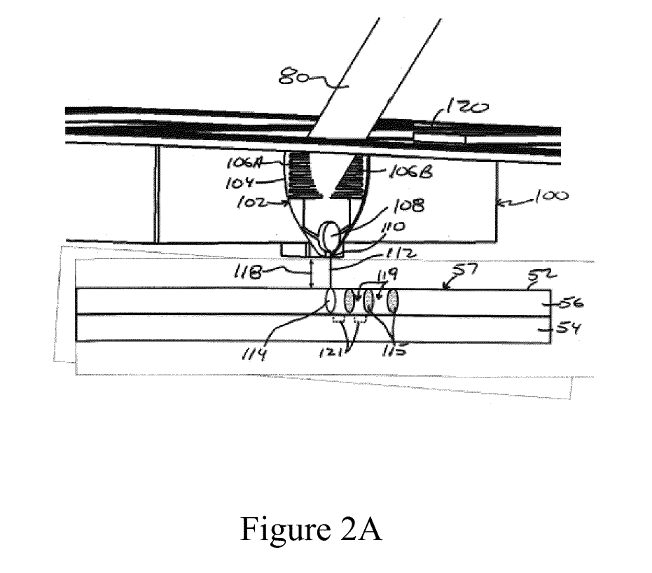

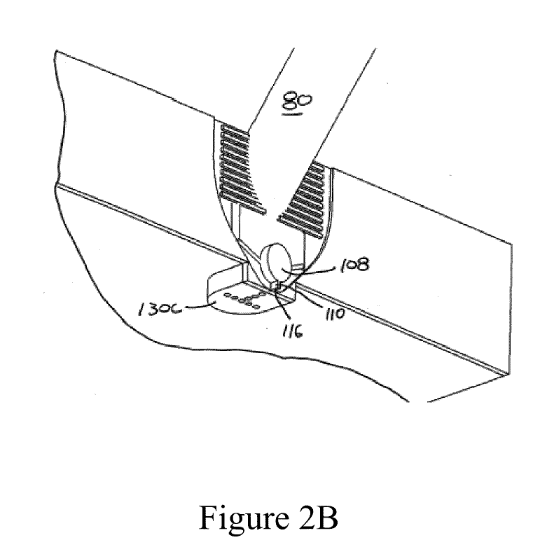

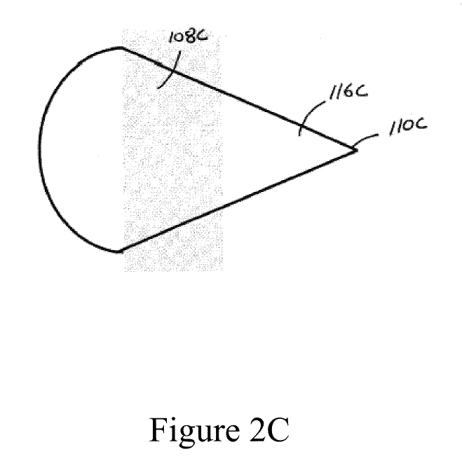

FIG. 2A is an enlarged view of a near field assembly 102 located on a side surface of a slider 100 in accordance with one embodiment of the present invention. Planar solid immersion mirror 104 with dual offset gratings 106A, 106B focuses radiation 80 onto near field transducer 108. The dual offset grating 106A, 106B are offset by half a wavelength of the radiation 80 causing a phase shift. The near field transducer 108 is located at the focus of the planar solid immersion mirror 104. When the near field transducer 108 is excited to surface plasmon resonance, tip 110 couples the light into the photo-resist 56. The tip 110 provides a lightning rod effect for field confinement. A near field assembly suitable for use in the present embodiment is disclosed in Challener, et al. Heat-assisted Magnetic Recording by a Near-field Transducer with Efficient Optical Energy Transfer, DOI: 10.1038 Nature Photonics (2009) and U.S. Pat. No. 7,272,079 (Challener), which are incorporated by reference.

Surface plasmons (SPs) are collective oscillations of surface charge that are confined to an interface between a dielectric and a metal. When surface plasmons are resonantly excited by the external optical field 80, the field amplitude of the output radiation 112 in the vicinity of the region 114 may be orders of magnitude greater than that of the incident radiation 80.

The region 114 of output radiation 112 is tightly confined, with a cross-sectional area much smaller than the incident wavelength 80. The region 114 is typically circular or oval in shape, although a variety of other shapes are possible. The region 114 preferably covers an area with a major dimension of less than about 100 nanometers, and more preferably less than about 80 nanometers, and more preferably less than about 60 nanometers.

The output radiation 112 from the near field transducer 108 heats the photo-mask 56 to form exposed regions 115 with different properties than the unexposed regions 119 of the photo-mask 56. The exposed regions 115 are depicted as corresponding to the size of the region 114 created from a single laser pulse. The size of the exposed regions 115, however, can be modified by varying the on-time of the laser, clearance 118, and a variety of other factors.

After exposure to heat from the output radiation 112, the photo-resist 56 forms a new material different from the unexposed regions. By controlling the position of the master 52 and the pulses from the laser assembly 74, the controller 70 can generate a predetermined pattern. The master 52 is then etched, such as by chemical etchants or reactive-ion-etching (RIE). The exposed regions 115 are resistant to the etching acting as a mask. The exposed regions 115 are resistant to hydrochloric acid mixtures (HCl:H.sub.2O.sub.2:H.sub.2O, 1:1:48) and nitric acid mixtures, while the unexposed regions 119 are removed in the same acid mixture.

The etching is performed into the substrate 54 so that after removal of the remaining photo-resist 56, the substrate 54 has the desired pattern features 121. The present system permits features 121 with dimensions less than the wavelength of the incident radiation 80. The features 121 preferably have a size less than about 50%, more preferably less than about 30%, and most preferably less than about 20%, of the wavelength of the incident radiation. The features 121 preferably have a maximum dimension of less than about 80 nanometers, and more preferably less than about 60 nanometers, and more preferably less than about 40 nanometers.

Due to the exponential decay of the evanescent field of surface plasmons, the tightly focused region 114 only exists at the near field of the near field transducer 108, normally less than about 100 nanometers. To achieve high-speed scanning, clearance 118 between distal end 116 of the tip 110 and surface 57 of the photo-resist 56 is preferably less than about 50 nanometers, and more preferably less than about 20 nanometers to about 10 nanometers, above the photo-resist layer 56.

As best illustrated in FIG. 2B, distal end 116 of the tip 110 is flush with air bearing surface 130C so that the clearance 118 is controlled by the gas bearing. In another embodiment, the tip 110 extends beyond the air bearing surface 130C toward the master 52. This embodiment permits the plasmon field to be closer to the photo-mask 56, while maintaining a greater clearance between the slider 60 and the surface 57 of the photo-resist 56.

FIG. 2C is a schematic illustration of an alternate near field transducer 108C in accordance with an embodiment of the present invention. Distal end 116C includes pointed tip 110C. The tip 110C concentrates energy from the transducer 108C. A variety of other shapes are possible for the tip 110C, depending on the shape and size of the desired exposed regions 115 (see FIG. 2A).

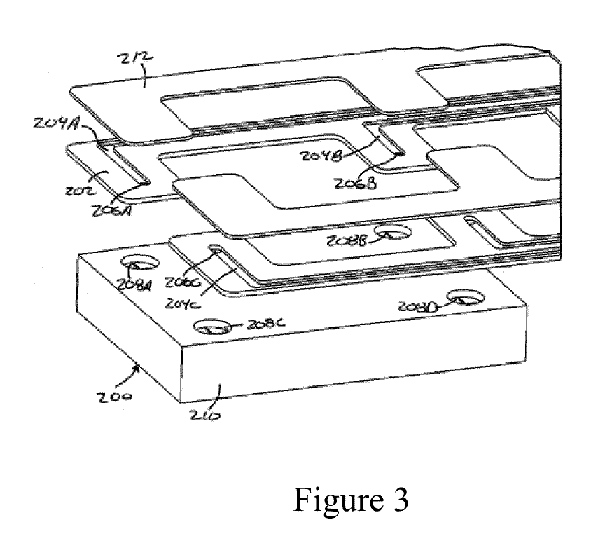

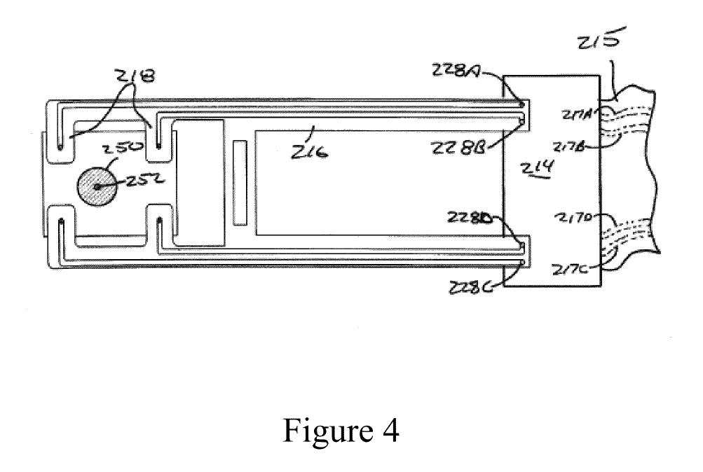

FIGS. 3 through 5 illustrate a suspension assembly 200 capable of generating a hydrostatic gas bearing in accordance with an embodiment of the present invention. Stainless steel suspension 202 is etched to create channels 204A, 204B, 204C, 204D (collectively “204”). In the illustrated embodiment, distal ends of the channels 204 terminate in through holes 206A, 206B, 206C, 206D (collectively “206”). The through holes 206 are configured to align with ports 208A, 208B, 208C, 208D (collectively “208”) in slider 210.

While the illustrated embodiment includes four channels and four ports 208 in the slider 210, a variety of other configurations are possible. In one embodiment, the channels 204A and 204B are combined into a single channel, as are 204C and 204D. As will be discussed herein, the number and/or the locations of ports 208 can also vary. In another embodiment, the channels 204 may be formed in the bottom surface of the suspension 202, making the holes 206 unnecessary.

Sealing layer 212 is located over the top of the channels 204 to form a substantially air-tight seal. In one embodiment, the sealing layer 212 is a polyamide sheet with a pressure sensitive adhesive on one surface. Pressurized gas can be delivered to the channels 204 from base plate 214 attached to load beam 216. In one embodiment, a multi-layered polyamide sheet 215 delivers pressurized gas from the controller 70 to the base plate 214. The polyamide sheet 215 includes conduits 217A, 217B, 217C, 217D (collectively “217”) fluidly coupled to through holes 228A, 228B, 228C, 228D in the base plate 214 and the load beam 216. The pressurized gas travels down the respective channels 204 to flexure 218, out through holes 206, and into the ports 208 on the slider 210.

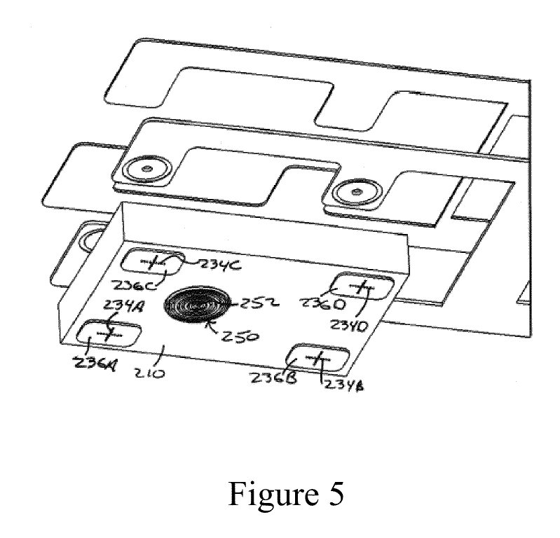

As best illustrated in FIG. 5, bottom surface 230 of the flexure 218 includes recesses 232 around the through holes 206. These recesses 232 mate with the ports 208 on the top of the slider 210. Each port 208 is fluidly coupled to a respective plurality of holes 234A, 234B, 234C, 234D (collectively “234”) formed in respective air bearing surfaces 236A, 236B, 236C, 236D (collectively “236”) on the base of the slider 210. The pressurized gas exits these holes 234 to form a gas bearing between the slider 210 and the master 52.

The controller 70 monitors gas pressure delivered to the slider 60. Gas pressure to each of the four channels 204 is preferably independently controlled so that the pitch and roll of the slider 60 can be adjusted. In another embodiment, the same gas pressure is delivered to each of the channels 204. While clean air is the preferred gas, other gases such as for example argon may also be used. The gas pressure is typically in the range of about 2 atmospheres to about 4 atmospheres.

The slider 210 includes an alternate near field assembly 250 in accordance with another embodiment of the present invention. The near field assembly 250 includes aperture 252 formed of a material, such as glass, quartz or another dielectric material, that is transmissive to radiation 80 at the wavelength of the laser assembly 74. A film 254 of material substantially reflective to the radiation 80 at the wavelength of the laser assembly 74 is located on the disk-facing side 256 around the aperture 252. The aperture 252 is preferably subwavelength-sized, i.e., its diameter if it is circularly-shaped or its smallest feature if it is non-circular, is less than the wavelength of the incident laser radiation 80 and preferably less than one-half the wavelength of the laser radiation 80. A suitable near field assembly 250 is disclosed in U.S. Pat. Publication No. US 2007/0069429.

Optical transmission through a subwavelength aperture in a metal film is enhanced when the incident radiation is resonant with surface plasmons at a corrugated metal surface 250 surrounding the aperture 252. Thus features such as ridges or trenches in the metal film 250 serve as a resonant structure to further increase the emitted radiation output from the aperture 252 beyond what it would be in the absence of these features. The effect is a frequency-specific resonant enhancement of the radiation emitted from the aperture 252, which is then directed onto the photo-resist 56 positioned within the near-field. This resonant enhancement is described by Thio et al., Enhanced Light Transmission Through A Single Subwavelength Aperture, Optics Letters, Vol. 26, Issue 24, pp. 1972-1974 (2001) and in US 2003/0123335.

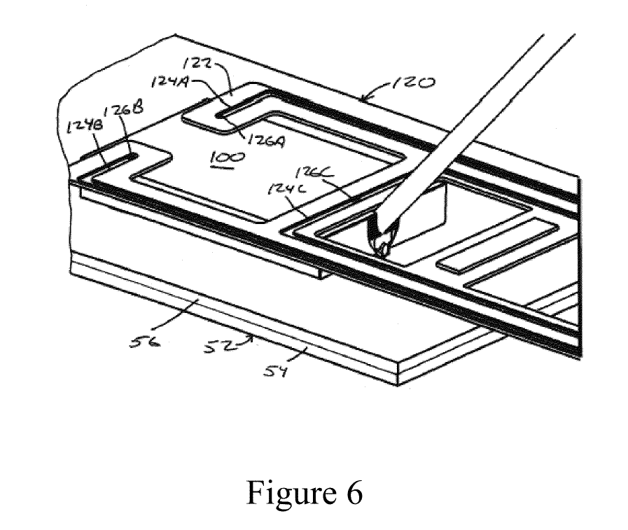

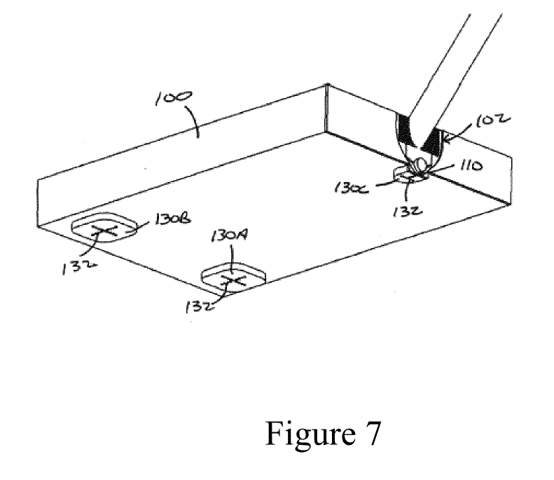

FIGS. 6 and 7 illustrate the slider 100 of FIGS. 2A and 2B as part of a suspension assembly 120 in accordance with an embodiment of the present invention. Top surface 122 of the suspension 120 is etched to form three channels 124A, 124B, and 124C (collectively “124”). The channels 124 terminate in through holes 126A, 126B, 126C (collectively “126”) fluidly coupled to ports through the slider 100. As best illustrated in FIG. 7, bottom surface 128 of the slider 100 includes three air bearing surfaces 130A, 130B, and 130C, each with a plurality of holes 132 fluidly coupled to the channels 124. The single pad 130C near the near field assembly 102 optimizes the tracking of the tip 110 with the waviness of the master 52. The four-pad design of FIG. 5, by contrast, averages the waviness of the master 52 across the entire lower surface of the slider 210.

The substrate 54 may be any suitable material, such as a wafer of single-crystal silicon. The photo-resist 56 is preferably a photo-resist that is generally insensitive to light with a wavelength greater than about 400 nm so that it can be handled in room light. The photo-resist is a material that changes its optical or chemical etching properties when heated by exposure to laser radiation.

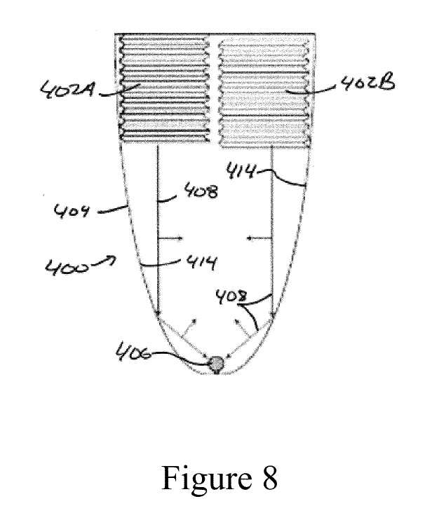

FIG. 8 illustrates an embodiment of a near field assembly 400 in accordance with an embodiment of the present invention. Dual offset gratings 402A, 402B (“402”) redirect incident electromagnetic radiation 408 to sidewalls 414 of planar solid immersion mirror 404. The near field transducer 406 is located at the focus of the planar solid immersion mirror 404. The dual offset gratings 402A, 402B are offset by half a wavelength of the incident radiation 408 causing a phase shift. When the near field transducer 406 is excited to surface plasmon resonance, tip 410 couples the radiation 408 onto the recording media 412.

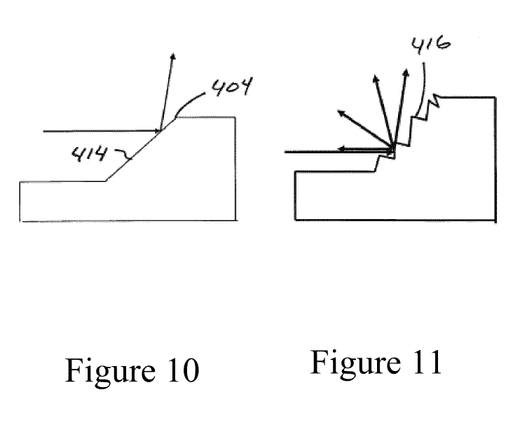

Near field assemblies are typically fabricated in an Alumina base material using ion milling or reactive ion etching. As illustrated in FIG. 10, non-perpendicular side walls 414 on the planar solid immersion mirror 404 divert light from reaching the near field transducer 406. As illustrated in FIG. 11, surface roughness 416 due to etching on any of the reflective surfaces, such as the offset grating 402 and the sidewalls 414 of the planar solid immersion mirror 404, also contributes to light scattering and thus reduced transmission efficiency. Theoretical formulations do not account for side wall slope 414 and wall roughness 416 in estimating the coupling efficiency of the incident radiation 408. There are no known ion bombardment processes known to resolve both the roughness issue and the wall slope.

The present near field assembly 400 is fabricated using conventional etching processes to remove the bulk of the material. The side walls 414 and the grating 402 are then micro machined with specially fabricated diamond tip coated miniature tool coated with nano diamonds or tools equipped with a single diamond tip. The single diamond tip provides very accurate but lengthy machining time. A machined tip coated with nano diamond is preferred in most cases due to the speed of the operation.

Specially shaped machining tools can be fabricated to machine the gratings requiring a particular angle. Conical tools can be readily fabricated and coated with nano diamonds to perform such operations. Various tooling and machining techniques for producing optical quality surfaces are disclosed in U.S. Pat. Nos. 6,581,286 (Cambell et al.); 7,445,409 (Trice et al.); and 7,510,462 (Bryan et al.), which are hereby incorporated by reference.

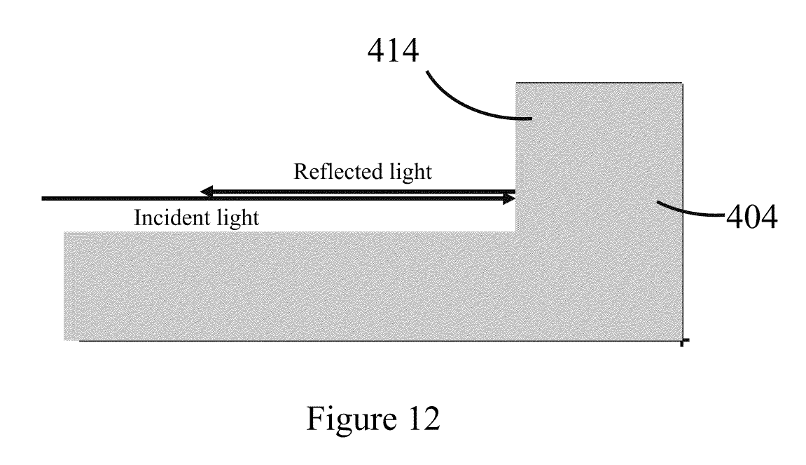

Near vertical side wall 414, such as illustrated in FIG. 12, are attained with the milling operation. A vision based system can be used to guide the milling operation to machine the side walls 414 of the parabolic planar solid immersion mirror 404, the edges of the near field transducer, and the gratings 402. Roughness and streaks of the critical surfaces 402, 406, 414 can be substantially reduced by a high speed machining operation involving nano diamonds attached to the milling tool. For best performance it is preferred to have machining tool with adhered nano diamonds to control surface finish.

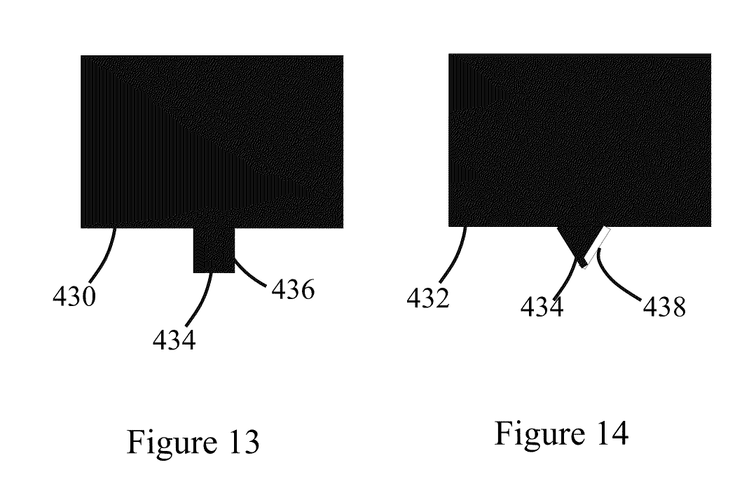

FIGS. 13 and 14 are cross sectional views of milling tool 430, 432 with nano-scale diamonds 434 adhered to the milling tips 436, 438. The nano-scale diamonds 434 can be adhered to the tools 430, 432 using a variety of techniques, such as for example adhesives or fusing. Alternatively, the tools 430, 432 can be coated with SiC, Titanium, diamond-like-carbon, and a variety of other materials. A multi-step machining cycle may be desirable to first machine vertical sidewalls and then polish to reduce surface roughness.

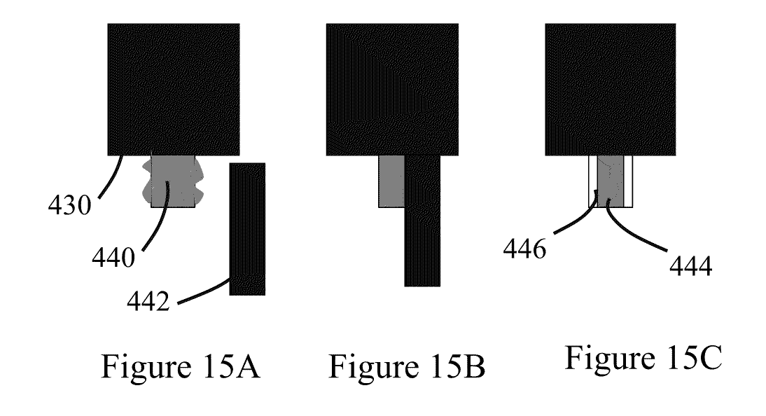

FIGS. 15A-15C illustrate a sequence of steps to prepare the tool 430 for machining optical surfaces on near field assemblies according to an embodiment of the present invention. Rotating cutting surface 440 is brought into engagement with a flat abrasive surface 442. The abrasive surface can be a hard metal or SiC. In one embodiment, the abrasive surface 442 has a layer of nano-scale diamonds 446. Multiple abrasive surfaces 442 with increasing smoothness can be used to prepare the cutting surface 440. Once the cutting surface 440 is polished, nano-scale diamonds are attached. An optional hard coat can be applied over the diamonds. The cutting tip 444 preferably has a diameter of about 300 micrometers to about 100 micrometers.

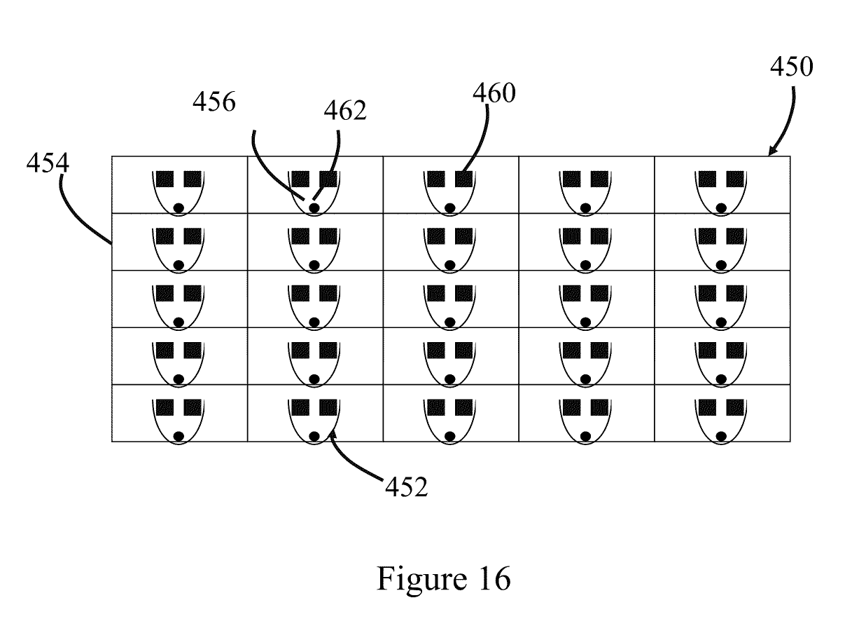

FIG. 16 illustrates a wafer 450 populated with a plurality of near field assemblies 452. The devices 452 are first patterned using photolithography methods. A vision system uses the features created by the etching process as a reference for the machining and polishing operations. The machining and polishing steps are primarily directed to the sidewalls 456 of the planar solid immersion mirror 458, the gratings 460 and the near field transducer 462. The top surface of the wafer can also be polished prior to gold/silver deposition. Wafer level machining operations are capable of generating near vertical sidewall profiles and smooth surface in the range of less than about 10 nanometer. Each cell 454 includes a complete near field assembly 452. The wafer 450 is subsequently cut into discrete components.

The high precision optical surfaces on near field assemblies made according to the present invention increase the efficiency of coupling light energy by about one order of magnitude, from about 2 percent to about 20 percent or more. These higher efficiency near field assemblies have application in nano-photolithography and heat assisted magnetic recording for hard disc drives. Various ways of employing the present near field assemblies for heat assisted magnetic recording on hard disc drives are disclosed in U.S. Pat. Nos. 6,944,112 (Challener); 7,106,935 (Challener); 7,272,079 (Challener); 7,330,404 (Peng et al.); 7,440,660 (Jin et al.); and U.S. Patent Publication Nos. 2006/0182393 (Sendur et al.) and 2008/0002298 (Sluzewski), which are hereby incorporated by reference.

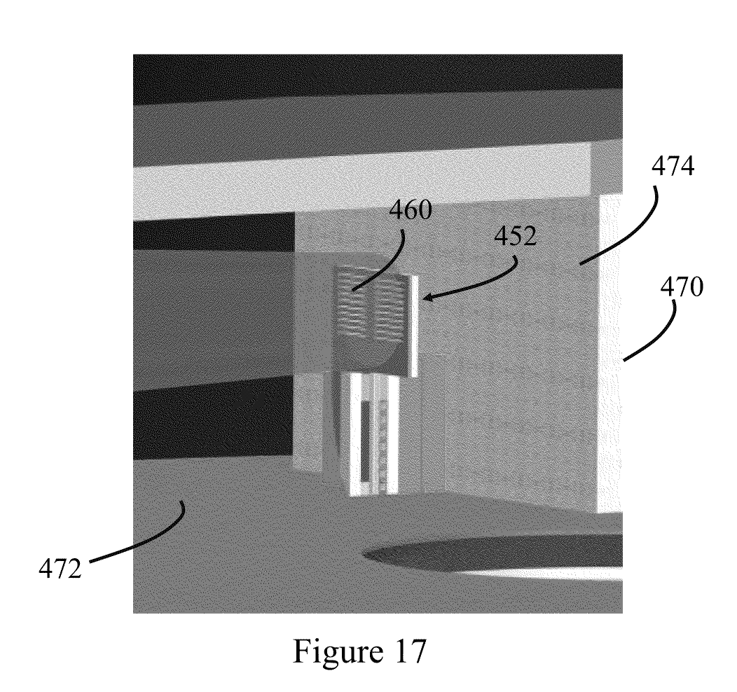

FIG. 17 illustrates a near field assembly 452 employed in a HAMR application in accordance with an embodiment of the present invention. The near field transducer 452 is attached to a read/write head 470 positioned above spinning magnetic media 472. Incident radiation 474 is preferably directed perpendicular to the gratings 460. The gratings 460 are preferably fabricated with about 45 degree surfaces to direct the incident radiation 470 into the planar solid immersion mirror 458, and ultimately the near field transducer 462.

FIGS. 18-19 illustrate a multi-layered gimbal assembly 530 in accordance with an embodiment of the present invention. In the illustrated embodiment, center layer 532 includes traces 534 that deliver compressed air from inlet ports 536 in the top layer 538 to exit ports 540 on the bottom layer 542. The exit ports 540 are fluidly coupled to the ports 508 on the button bearings 504. As best illustrated in FIG. 19, the inlet ports 536 are offset and mechanically decoupled from the gimbal mechanism 544.

Where a range of values is provided, it is understood that each intervening value, to the tenth of the unit of the lower limit unless the context clearly dictates otherwise, between the upper and lower limit of that range and any other stated or intervening value in that stated range is encompassed within the inventions. The upper and lower limits of these smaller ranges which may independently be included in the smaller ranges is also encompassed within the inventions, subject to any specifically excluded limit in the stated range. Where the stated range includes one or both of the limits, ranges excluding either or both of those included limits are also included in the inventions.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described. All patents and publications mentioned herein, including those cited in the Background of the application, are hereby incorporated by reference to disclose and describe the methods and/or materials in connection with which the publications are cited.

The publications discussed herein are provided solely for their disclosure prior to the filing date of the present application. Nothing herein is to be construed as an admission that the present inventions are not entitled to antedate such publication by virtue of prior invention. Further, the dates of publication provided may be different from the actual publication dates which may need to be independently confirmed.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

1. A photolithography system for creating a pattern of exposed regions in a photo-resist layer on a substrate, the photolithography system comprising:
a slider suspension assembly comprising a load beam having a flexure at a distal end, and;
a source of pressurized gas;
at least one gas conduit;
a slider comprising:
a first surface attached to the flexure;
a second surface facing the substrate; and
a trailing edge between the first surface and the second surface, the slider including a plurality of ports in fluid communication with the at least one gas conduit, the plurality of ports extending through the slider from the first surface to the second surface, the ports terminating at the second surface wherein gas exiting the plurality of ports combines with the second surface as at least one air bearing surface, the slider having a plurality of channels therein;
a laser assembly adapted to supply incident radiation;
a near field assembly associated with the trailing edge of the slider, the near field assembly positioned on the slider to develop portions of a layer of photo-resist to form the pattern on the substrate in response to incident laser irradiation directed at the near field assembly by the laser assembly, wherein a clearance between the near field assembly and the photo-resist layer is maintained by pressurized gas at the second surface; and
a controller adapted to synchronize activation of the laser assembly with the position of the substrate relative to the near field assembly.

2. The photolithography system of claim 1 further comprising:
a base plate at a proximal end of the head suspension; and
a flexible conduit fluidly coupling the at least one conduits on the head suspension to the source of pressurized gas.

3. The photolithography system of claim 1 wherein the near field assembly comprises a near field transducer located on the trailing edge of the slider near the second surface.

4. The photolithography system of claim 1 wherein the pattern comprises pattern features having dimensions less than about a wavelength of the incident radiation.

5. The photolithography system of claim 1 wherein the at least one gas conduit is a plurality of gas conduits.

6. The photolithography system of claim 1 further comprising a stage, the substrate secured to the stage, the controller controlling the movement of the stage to form the pattern.

7. The photolithography system of claim 1 further comprising a motor attached to the slider, the controller controlling the movement of the motor and the slider with respect to the substrate to form the pattern.

8. A plasmonic head for creating a pattern of exposed regions in a photo-resist layer on a substrate, the plasmonic head comprising:
a slider suspension assembly comprising a load beam having a flexure at a distal end, and a plurality of channels;
at least one gas conduit;
a slider comprising:
a first surface attached to the flexure;
a second surface facing the substrate; and
a trailing edge located between the first surface and the second surface, the first surface of the slider including a plurality of ports fluidly coupled to the at least one gas conduit, the ports extending through the slider and exiting through openings within the slider at the second surface, the ports adapted to emit a gas to maintain a clearance between the second surface and the photo-resist layer; and
a near field assembly located proximate the trailing edge of the slider and near the second surface of the slider, the near field assembly adapted to develop photo-resist on a surface near the slider.

9. The plasmonic head of claim 8 further including a structure for converting incident radiation directed toward the near field assembly to energy that develops the photo-resist.

10. The plasmonic head of claim 9 wherein the structure of the near field assembly is formed by etching.

11. The plasmonic head of claim 9 wherein the structure of the near field assembly is formed by machining.

12. A method for forming a pattern in photo-resist layer on a substrate using a photolithography system, the method comprising:
delivering a pressurized gas through at least one gas conduit in an air bearing surface on a slider to create a hydrostatic gas bearing at the air bearing surface, the hydrostatic gas bearing providing a clearance between a near field assembly and a photo-resist layer;
directing incident radiation from a laser assembly to the near field assembly; and
emitting a region of radiation from the near field assembly onto the photo-resist in response to the incident radiation.

13. The method of claim 11 wherein emitting a region of radiation from the near field assembly is sufficient to develop the photo-resist.

14. The method of claim 11 further comprising moving one of the substrates or the slider.

15. The method of claim 11 wherein emitting a region of radiation from the near field assembly is sufficient to develop the photo-resist, the method further comprising:
moving one of the substrates or the slider; and
synchronizing activation of the laser assembly with a position the substrate relative to the near field assembly to form the pattern.

16. A method of fabricating a near field assembly comprising:
fabricating a plurality of near field assemblies on a wafer, each of the near field assemblies comprising a planar solid immersion mirror, at least one grating, and a near field transducer; and
using features created during the fabrication process to guide at least one milling tool to machine at least one surface of the planar solid immersion mirror, the at least one grating, or the near field transducer.

17. The method of fabricating a near field assembly of claim 15 further comprising using features created during the fabrication process to guide at least one polishing tool to polish at least one surface of the planar solid immersion mirror, the at least one grating, or the near field transducer.

18. The method of claim 16 comprising directing the at least one milling tool and the at least one polishing tool with a machine vision system.

19. The method of claim 15 comprising coating a cutting surface of the milling tool with a plurality of nano-scale diamonds.

20. The method of claim 6 comprising the steps of:
mounting at least one of the near field assemblies on a head suspension assembly above rotating magnetic media in a hard disk drive; and
direct incident radiation at the grating so the near field assembly emits radiation onto at least one region of the rotating magnetic media.

21. A substrate that includes a plurality of near field assemblies fabricated according to the method of claim 16.

22. A master substrate formed by
placing a layer of photolithographic material over the substrate;
moving a slider having an air bearing surface with respect to the substrate, the slider also including a near field assembly that converts direct incident radiation into radiation for developing a portion of the layer of photolithographic material proximate the near field assembly;
controlling the timing of the incident radiation and the moving of the slider to produce a desired pattern of developed photolithographic material on the surface of the substrate.

23. The master substrate of claim 21 further formed by removing selected portions of one of the developed or undeveloped photolithographic material.

24. The master substrate of claim 22 further formed by removing additional material by way of machining using the patterns formed by developing the photolithographic material.

25. A method of forming a slave from the master of claim 23 by photo imprinting a slave substrate using the master.

26. The method of claim 24 further comprising using a slave to fabricate a pattern on a substrate.

27. A tool for removing material from a substrate that includes at least one feature formed by developing photolithographic material, removing one of the developed or undeveloped photolithographic material and etching the substrate, the tool further comprising:
a shaped machining tool;
nano diamonds associated with the outer surface of the shaped machining tool.

28. The tool for removing material of claim 26 wherein the shaped machining tool includes a selected angle used in fabricating a grating on a substrate.

29. The tool for removing material of claim 27 further including a vision system used to guide the angled tool in forming the grating.

30. The tool for removing material of claim 26 wherein the shaped tool is a conical tool used to remove material from a substrate to form a planar immersion mirror.

31. The tool for removing material of claim 29 further including a vision system used to guide the conical tool in forming the planar immersion mirror.
